(19) United States
(12) Patent Application Publication
(10) Pub. No.: US 2017/0024047 A1
(43) Pub. Date: Jan. 26, 2017

(54) DISPLAY MODULE WITH PRESSURE SENSOR

(71) Applicant: FocalTech Electronics, Ltd., Grand Cayman (KY)

(72) Inventor: Chen-Pang Kung, Hsinchu County (TW)

(21) Appl. No.: 14/986,848

(22) Filed: Jan. 4, 2016

(30) Foreign Application Priority Data
Jul. 22, 2015 (CN) 201510434883.1

(51) Int. Cl. G06F 3/041; G06F 3/044

(52) U.S. Cl. CPC G06F 3/0414; G06F 3/0412; G06F 3/0416; G06F 3/044; G06F 2203/04105

(57) ABSTRACT

A display module includes a front panel, a backlight panel, a pressure sensor and a panel frame. The front panel includes an array of display pixels. The backlight panel is disposed under the front panel. The pressure sensor is disposed under the backlight panel. The panel frame is disposed under the pressure sensor. When an applied pressure is received by the front panel, a magnitude of the applied pressure is sensed by the pressure sensor.

This application claims the benefit of People's Republic of China Patent Application No. 201510434883.1, filed Jul. 22, 2015, the subject matter of which is incorporated herein by reference.

### FIELD OF THE INVENTION

The present invention relates to a display module, and more particularly to a display module with a pressure sensor.

### BACKGROUND OF THE INVENTION

FIGS. 1A˜1D are schematic views illustrating a conventional pressure sensor and a display module with the pressure sensor. The pressure sensor is disclosed in U.S. Pat. No. 8,669,952.

As shown in FIG. 1A, the pressure sensor 100 comprises a sealed chamber 102, a top surface 104, a first electrode 106, a second electrode 108 and a bottom surface 118. An elastic polymer medium 110 with distributed metallic nanoparticles 112 is filled in the sealed chamber 102. The first electrode 106 is formed on the top surface 104. The second electrode 108 is formed on the bottom surface 118. Moreover, the first electrode 106 and the second electrode 108 are transparent electrodes such as indium tin oxide (ITO) electrodes.

Please refer to FIG. 1B. In response to an applied pressure 116 on the top surface 104, the distance between the first electrode 106 and the second electrode 108 is decreased and the elastic polymer medium 110 is compressed. That is, the distance between the metallic nanoparticles 112 is changed in response to an applied pressure 116 on the top surface 104. As the applied pressure is increased, the distance between the metallic nanoparticles 112 is decreased. Consequently, the electrical resistance between the first electrode 106 and the second electrode 108 is decreased.

In case that no pressure is applied to the pressure sensor 100 (see FIG. 1A), the electrical resistance between the first electrode 106 and the second electrode 108 is R1. In case that the pressure 116 is applied to the pressure sensor 100 (see FIG. 1B), the electrical resistance between the first electrode 106 and the second electrode 108 is R2, wherein R1>R2.

FIG. 1C is a schematic top view illustrating a display module with the pressure sensor. FIG. 1D is a schematic cross-sectional view illustrating the display module of FIG. 1C and taken along the line 2B. The display module 200 comprises a front panel 201 with an array of display pixels 202, a backlight panel 204 underlying the front panel 201, and a touchscreen 206 overlying the front panel 201. The touchscreen 206 comprises an array of pressure sensor cells 100. The pressure sensor cell 100 mn is also referred as a sensing node.

Generally, each of the pressure sensor cells 100 has the structure as shown in FIG. 1A. Take the pressure sensor cell 100 mn as an example. The pressure sensor cell 100 mn comprises a sealed chamber, a top surface, a first electrode 106n, a second electrode 108a and a bottom surface. As shown in FIG. 10, the relationship between the input and the output can be used to judge which pressure sensor cell receives the applied pressure. Moreover, the magnitude of the pressure applied to the pressure sensor cell can be determined according to the electrical resistance between a first electrode and a second electrode.

FIGS. 2A˜2D are schematic views illustrating a conventional pressure-sensitive cell. The pressure-sensitive cell is disclosed in U.S. Pat. No. 8,736,574.

As shown in FIG. 2A, a matrix 300 comprises plural pressure-sensitive cells. The electrical resistance of the pressure-sensitive cell is changed according to the amount of force applied thereto. Generally, the electrical resistance of the pressure-sensitive cell is in reverse proportion to the amount of force applied thereto.

The matrix 300 has a first layer 322 including plural column conductors 324. The matrix 300 also has a second layer 326 including plural row conductors 328. The second layer 326 is made of a flexible material. When a force is applied to the second layer 326, the second layer 326 is temporarily subjected to deformation.

As shown in FIG. 2B, each intersection of a column conductor 324 on the first layer 322 and a row conductor 328 on the second layer 326 establishes a pressure-sensitive cell 336. The pressure-sensitive cell 336 further comprises a force-sensitive resistive material 338. The column conductor 324 and the row conductor 328 are covered by the force-sensitive resistive material 338.

Generally, if no force is applied to the pressure-sensitive cell 336, the force-sensitive resistive material 338 on the column conductor 324 and the force-sensitive resistive material 338 on the row conductor 328 are not in contact with each other. If the force applied to the pressure-sensitive cell 336 exceeds a smallest threshold force, the force-sensitive resistive material 338 on the column conductor 324 and the force-sensitive resistive material 338 on the row conductor 328 are in contact with each other.

For achieving the above purposes, as shown in FIG. 2C, the pressure-sensitive cell 336 further comprises islands 374 and lands 375. The islands 374 and the lands 375 are disposed on the first layer 322 and the second layer 326, respectively. Moreover, the column conductors 324 and the row conductors 328 are electrically isolated by spacers 344. Consequently, if no force is applied to the pressure-sensitive cell 336, the force-sensitive resistive material 338 on the column conductor 324 and the force-sensitive resistive material 338 on the row conductor 328 are not in contact with each other.

The pressure-sensitive cell 336 further comprises a force-spreading layer 346. The force-spreading layer 346 is used for diffusing the force of the touch input at a contact area to two or more pressure-sensitive cells within matrix 320. The force-spreading layer 346 comprises bumps 348. The bumps 348 are in contact with the second layer 326. Consequently, when a force is applied to the force-spreading layer 346, the force is transferred to the second layer 326 through the bump 348. The force-spreading layer 346 further comprises troughs 78. The troughs 78 are arranged between the bumps and aligned with the corresponding islands 374 and the corresponding lands 375.

Please refer to FIG. 2D. When a force is applied to a contact area 350 of the matrix 320, the force-spreading layer 346 is subjected to deformation. Consequently, the bumps 348 and 347 are in contact with the second layer 325, and the force is transferred to the pressure-sensitive cells 352, 353 and 354 of the matrix 320. Under this circumstance, the force-sensitive resistive material 338 on the second layer 326 and the force-sensitive resistive material 338 on the first layer 322 at the locations 356, 357 and 358 of the pressure-sensitive cells 352, 353 and 354 are in contact with each other. Consequently, the electrical resistances of the pressure-sensitive cells 352, 353 and 354 are decreased. Moreover, since the islands 374 and the lands 375 are separated from each other by the spacers 344, the force-sensitive resistive material 338 on the second layer 326 and the force-sensitive resistive material 338 on the first layer 322 at the locations corresponding to the islands 374 and the lands 375 are not in contact with each other.

From the above discussions, the conventional pressure sensors are disposed over a LCD display module, or disposed over an AMOLED display module, or installed in an outer frame of the display module, or integrated into the LCD pixels. However, regardless of the configurations of the pressure sensors, the pressure sensors are disposed over the backlight panel. In such configuration, the illuminance of the display module is reduced. Moreover, since the structures of the conventional pressure sensors are complicated, the process yield of the display module is impaired.

### SUMMARY OF THE INVENTION

The present invention provides a display module with a pressure sensor. The pressure sensor is disposed under a backlight panel of the display module. Consequently, the illuminance of the display module is not adversely affected by the pressure sensor.

An embodiment of the present invention provides a display module. The display module includes a front panel, a backlight panel, a pressure sensor and a panel frame. The front panel includes an array of display pixels. The backlight panel is disposed under the front panel. The pressure sensor is disposed under the backlight panel. The panel frame is disposed under the pressure sensor. When an applied pressure is received by the front panel, a magnitude of the applied pressure is sensed by the pressure sensor.

Another embodiment of the present invention provides a display module. The display module includes a front panel, a pressure sensor and a panel frame. The front panel includes an array of display pixels. The pressure sensor is disposed under the front panel, and comprising a reflective layer. The panel frame is disposed under the pressure sensor. When an applied pressure is received by the front panel, a magnitude of the applied pressure is sensed by the pressure sensor.

A further embodiment of the present invention provides a display module. The display module includes a front panel, a backlight panel and a pressure sensor. The front panel includes an array of display pixels. The backlight panel is disposed under the front panel. The pressure sensor is disposed under the backlight panel, and includes a panel frame. The panel frame is located at a lower portion of the pressure sensor. When an applied pressure is received by the front panel, a magnitude of the applied pressure is sensed by the pressure sensor.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1A˜1D (prior art) are schematic views illustrating a conventional pressure sensor and a display module with the pressure sensor;

FIGS. 2A˜2D (prior art) are schematic views illustrating a conventional pressure-sensitive cell;

FIG. 3A is a schematic view illustrating a display module with a pressure sensor according to an embodiment of the present invention;

FIG. 3B is a schematic view illustrating the structure of the pressure sensor of the display module of FIG. 3A;

FIG. 3C is a schematic view illustrating the pressure sensor of FIG. 3B in response to an applied pressure;

FIGS. 4A˜4H are schematic cross-sectional views illustrating some examples of the pressure sensor according to the present invention; and

FIG. 5 schematically illustrates some kinds of patterned electrodes.

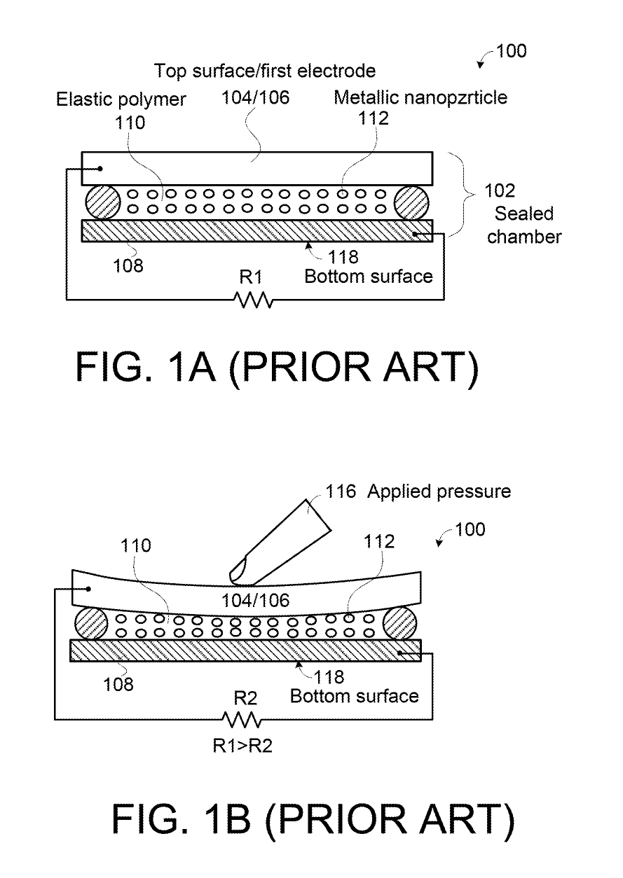

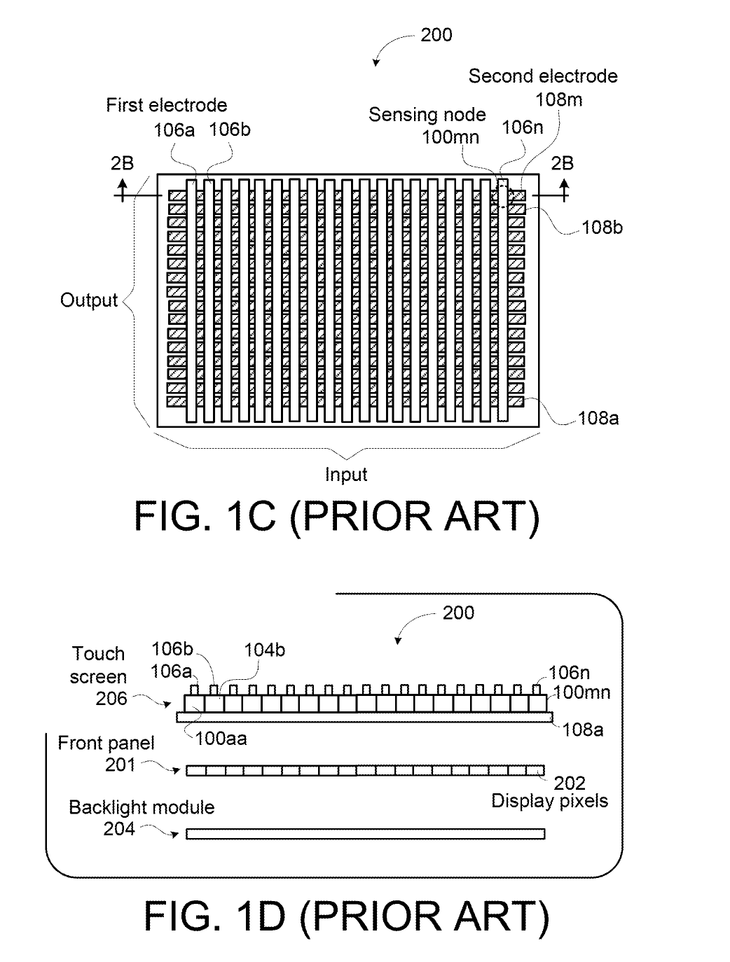

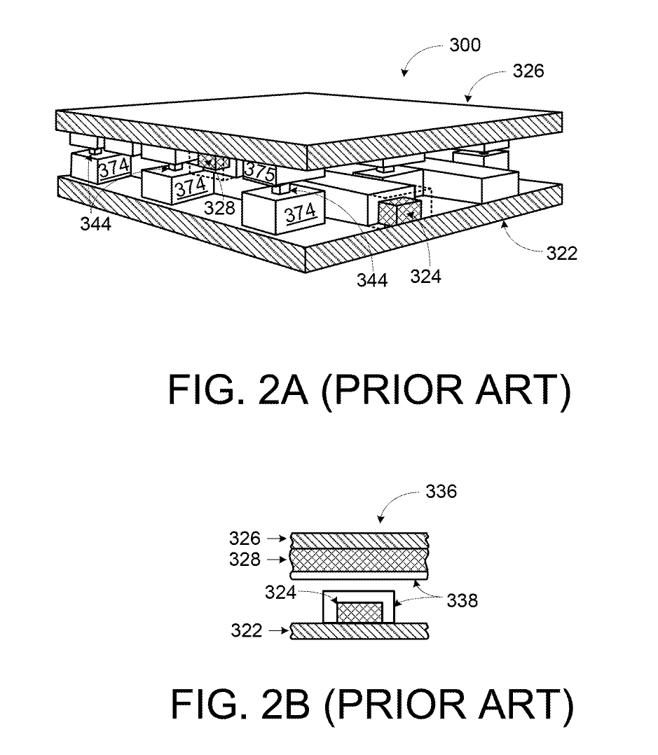

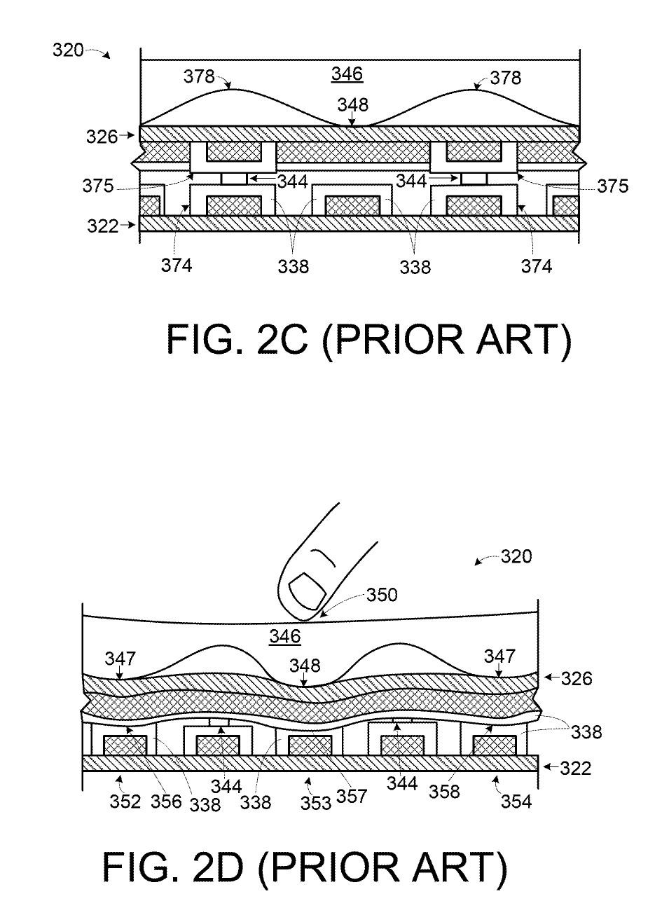

### DETAILED DESCRIPTION OF PREFERRED EMBODIMENTS

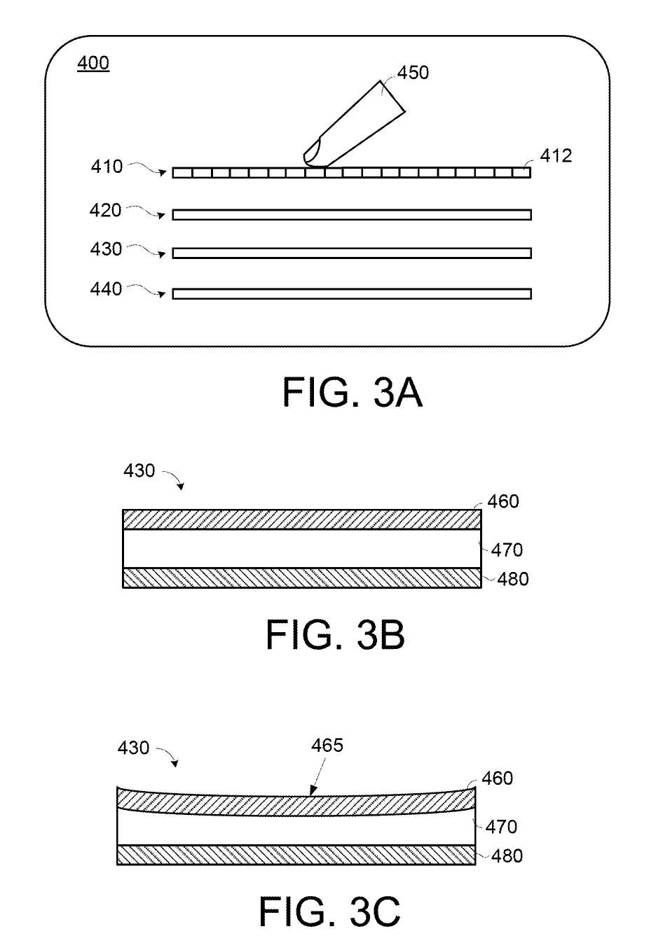

FIG. 3A is a schematic view illustrating a display module with a pressure sensor according to an embodiment of the present invention. As shown in FIG. 3A, the display module 400 at least comprises a panel frame 440, a pressure sensor 430, a backlight panel 420 and a front panel 410, which are arranged in a stack form. The front panel 410 comprises an array of display pixels 412. The front panel 410 further comprises a touch control layer (not shown). A finger 450 of a user can be placed on the touch control layer of the front panel 410 to perform touch control.

Please refer to FIG. 3A again. The backlight panel 420 is disposed under the front panel 410. The pressure sensor 430 is disposed under the backlight panel 420. The panel frame 440 is disposed under the pressure sensor 430. In an embodiment, the backlight panel 420, the pressure sensor 430 and the panel frame 440 are attached on each other. Since the pressure sensor 430 is arranged between the backlight panel 420 and the panel frame 440, the illuminance of the display module 400 is not adversely affected by the pressure sensor 430.

FIG. 3B is a schematic view illustrating the structure of the pressure sensor of the display module of FIG. 3A. The pressure sensor 430 comprises a first substrate 460, an interlayer 470 and a second substrate 480. The interlayer 470 is arranged between the first substrate 460 and the second substrate 480. For example, the interlayer 470 is a dielectric interlayer or a resistive layer. Moreover, the first substrate 460 comprises a top electrode layer, and the second substrate 480 comprises a bottom electrode layer. According to a signal change between the top electrode layer and the bottom electrode layer, the pressure sensing operation can be performed.

FIG. 3C is a schematic view illustrating the pressure sensor of FIG. 3B in response to an applied pressure. In this embodiment, the first substrate 460, the interlayer 470 and the second substrate 480 are flexible. Consequently, when the display module 400 receives an applied pressure 465, the applied pressure 465 is transferred to the pressure sensor 430. Under this circumstance, the first substrate 460 is subjected to deformation so as to compress the interlayer 470.

In case that the interlayer 470 is the dielectric interlayer, the magnitude of the applied pressure on the display module 400 is sensed according to a change of a capacitance between the first substrate 460 and the second substrate 480. Whereas, in case that the interlayer 470 is the resistive layer, the magnitude of the applied pressure on the display module 400 is sensed according to a change of an electrical resistance between the first substrate 460 and the second substrate 480.

In this embodiment, the combination of the front panel 410 and the backlight panel 420 can be considered as an illumination module of the display module 400. Moreover, an example of the illumination module includes but is not limited to a LCD illumination module or an organic light-emitting module.

Moreover, the surface of the display module that is in contact with the finger 450 may be considered as a light-outputting surface of the illumination module. Consequently, the bottom surface of the backlight panel 420 is a backside surface of the illumination module. The backside surface and the light-outputting surface are two opposite surfaces of the illumination module. In addition, the pressure sensor 430 is arranged between the backside surface of the backlight panel 420 and the panel frame 440.

In an embodiment, the pressure sensor 430 is a stand-alone pressure sensor. In some other embodiments, the pressure sensor 430 may be integrated with the backlight panel or the panel frame. Similarly, the pressure sensor 430 comprises a top electrode layer, a bottom electrode layer, and an interlayer between the top electrode layer and the bottom electrode layer. In case that the pressure sensor 430 is integrated with the backlight panel, a metal layer on the backside surface of the illumination module is shared with the top electrode layer. In case that the pressure sensor 430 is integrated with the panel frame, a metal layer on the top surface of the panel frame is shared with the bottom electrode layer. Hereinafter, some examples of the pressure sensor of the present invention will be illustrated.

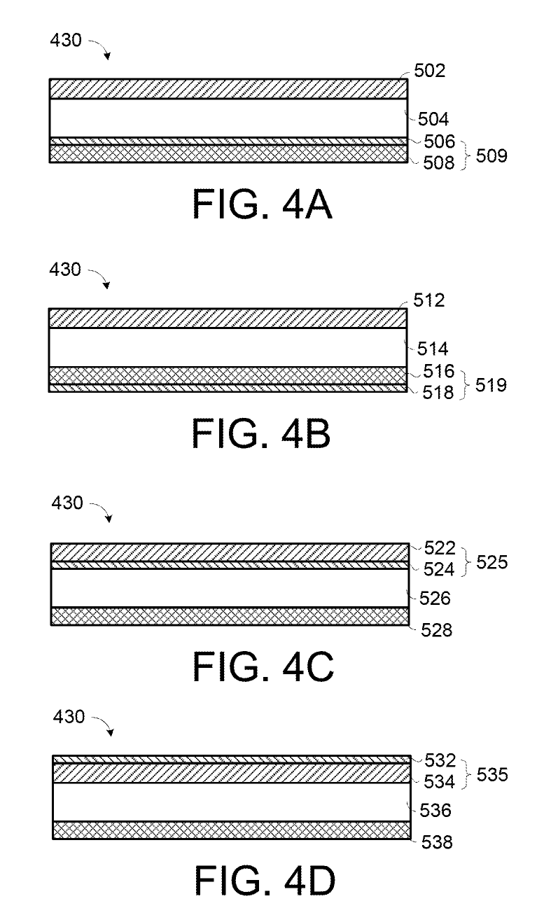

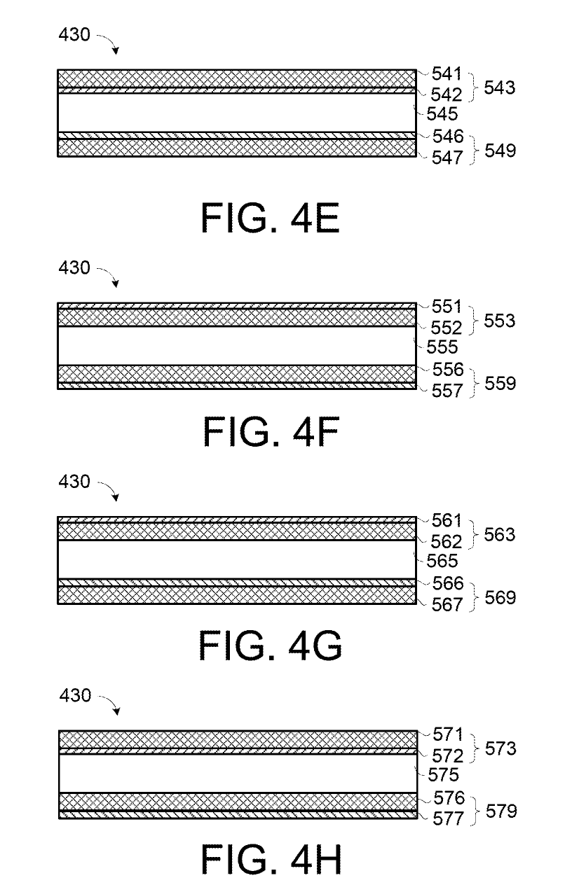

FIG. 4A is a schematic cross-sectional view illustrating a first example of the pressure sensor according to the present invention. As shown in FIG. 4A, the pressure sensor 430 comprises a first substrate 502, an interlayer 504 and a second substrate 509. The first substrate 502 is a top substrate, and made of metallic material. That is, the first substrate 502 is a metal substrate, and used as a top electrode layer. The second substrate 509 comprises a bottom electrode layer 506 and a bottom substrate 508. The bottom electrode layer 506 is made of metallic material or indium tin oxide (ITO). Moreover, the interlayer 504 is arranged between the first substrate 502 and the bottom electrode layer 506. In this embodiment, the interlayer 504 is a dielectric interlayer or a resistive layer.

In case that the pressure sensor 430 is a stand-alone pressure sensor, the first substrate 502 (i.e., the top substrate) further comprises plural top sub-electrodes (not shown), and the bottom electrode layer 506 further comprises plural bottom sub-electrodes (not shown). According to the changes of capacitances or electrical resistances between the top sub-electrodes and the corresponding bottom sub-electrodes, the magnitude of the applied pressure on the display module can be sensed.

In case that the pressure sensor 430 is integrated with the backlight panel, the first substrate 502 can be used as a reflective layer of the backlight panel for reflecting the light beam to the front panel of the display module because the first substrate 502 is a metal substrate and used as the top electrode layer. When the first substrate 502 is used as the reflective layer, the bottom electrode layer 506 further comprises plural bottom sub-electrodes (not shown). According to the changes of capacitances or electrical resistances between the first substrate 502 and the bottom sub-electrodes, the magnitude of the applied pressure on the display module can be sensed.

In case that the pressure sensor 430 is integrated with the panel frame, the panel frame is used as the bottom substrate 508, and a ground metal layer is formed on the panel frame to be used as the bottom electrode layer 506. Consequently, the second substrate 509 is constituted by the bottom electrode layer 506 and the bottom substrate 508. Since the pressure sensor 430 is integrated with the panel frame, the first substrate 502 further comprises plural top sub-electrodes. According to the changes of capacitances or electrical resistances between the top sub-electrodes and the bottom electrode layer 506, the magnitude of the applied pressure on the display module can be sensed.

FIG. 4B is a schematic cross-sectional view illustrating a second example of the pressure sensor according to the present invention. As shown in FIG. 4B, the pressure sensor 430 comprises a first substrate 512, an interlayer 514 and a second substrate 519. The first substrate 512 is a top substrate, and made of metallic material. That is, the first substrate 512 is a metal substrate, and used as a top electrode layer. The second substrate 519 comprises a bottom electrode layer 518 and a bottom substrate 516. The bottom electrode layer 518 is made of metallic material or indium tin oxide (ITO). Moreover, the interlayer 514 is arranged between the first substrate 512 and the bottom substrate 516. In this embodiment, the interlayer 504 is a dielectric interlayer.

In case that the pressure sensor 430 is a stand-alone pressure sensor, the first substrate 502 (i.e., the top substrate) further comprises plural top sub-electrodes (not shown), and the bottom electrode layer 518 further comprises plural bottom sub-electrodes (not shown). According to the changes of capacitances between the top sub-electrodes and the corresponding bottom sub-electrodes, the magnitude of the applied pressure on the display module can be sensed.

In case that the pressure sensor 430 is integrated with the backlight panel, the first substrate 512 can be used as a reflective layer of the backlight panel for reflecting the light beam to the front panel of the display module. When the first substrate 512 is used as the reflective layer, the bottom electrode layer 518 further comprises plural bottom sub-electrodes (not shown). According to the changes of capacitances or electrical resistances between the first substrate 512 and the bottom sub-electrodes, the magnitude of the applied pressure on the display module can be sensed.

In case that the pressure sensor 430 is integrated with the panel frame, the panel frame is used as the bottom substrate 516, and a ground metal layer is formed on the panel frame to be used as the bottom electrode layer 518. Consequently, the second substrate 519 is constituted by the bottom electrode layer 518 and the bottom substrate 516. Since the pressure sensor 430 is integrated with the panel frame, the first substrate 502 further comprises plural top sub-electrodes. According to the changes of capacitances between the top sub-electrodes and the bottom electrode layer 518, the magnitude of the applied pressure on the display module can be sensed.

FIG. 4C is a schematic cross-sectional view illustrating a third example of the pressure sensor according to the present invention. As shown in FIG. 4C, the pressure sensor 430 comprises a first substrate 525, an interlayer 526 and a second substrate 528. The first substrate 525 comprises a top electrode layer 524 and a top substrate 522. The top electrode layer 524 is made of metallic material or indium tin oxide (ITO). In addition, the top substrate 522 is a transparent substrate such as a glass substrate or a plastic substrate. The second substrate 528 is a bottom substrate, and made of metallic material. That is, the second substrate 528 is a metal substrate, and used as a bottom electrode layer. Moreover, the interlayer 526 is arranged between the top electrode layer 524 and the second substrate 528. In this embodiment, the interlayer 526 is a dielectric interlayer or a resistive layer.

In case that the pressure sensor 430 is a stand-alone pressure sensor, the top electrode layer 524 further comprises plural top sub-electrodes (not shown), and the second substrate 528 (i.e., the bottom substrate) further comprises plural bottom sub-electrodes (not shown). According to the changes of capacitances or electrical resistances between the top sub-electrodes and the corresponding bottom sub-electrodes, the magnitude of the applied pressure on the display module can be sensed.

In case that the pressure sensor 430 is integrated with the backlight panel, the top electrode layer 524 can be used as a reflective layer of the backlight panel for reflecting the light beam to the front panel of the display module because the top substrate 522 is the transparent substrate. When the top electrode layer 524 is used as the reflective layer, the second substrate 528 (i.e., the bottom substrate) further comprises plural bottom sub-electrodes (not shown). According to the changes of capacitances or electrical resistances between the top electrode layer 524 and the bottom sub-electrodes, the magnitude of the applied pressure on the display module can be sensed.

In case that the pressure sensor 430 is integrated with the panel frame, the second substrate 528 is considered as the panel frame, and used as a ground metal layer. Since the pressure sensor 430 is integrated with the panel frame, the top electrode layer 524 further comprises plural top sub-electrodes. According to the changes of capacitances or electrical resistances between the top sub-electrodes and the second substrate 528, the magnitude of the applied pressure on the display module can be sensed.

FIG. 4D is a schematic cross-sectional view illustrating a fourth example of the pressure sensor according to the present invention. As shown in FIG. 4D, the pressure sensor 430 comprises a first substrate 535, an interlayer 536 and a second substrate 538. The first substrate 535 comprises a top electrode layer 532 and a top substrate 534. The top electrode layer 532 is made of metallic material. The second substrate 528 is a bottom substrate, and made of metallic material. That is, the second substrate 528 is a metal substrate, and used as a bottom electrode layer. Moreover, the interlayer 536 is arranged between the top substrate 534 and the second substrate 538. In this embodiment, the interlayer 536 is a dielectric interlayer.

In case that the pressure sensor 430 is a stand-alone pressure sensor, the top electrode layer 532 further comprises plural top sub-electrodes (not shown), and the second substrate 538 (i.e., the bottom substrate) further comprises plural bottom sub-electrodes (not shown). According to the changes of capacitances between the top sub-electrodes and the corresponding bottom sub-electrodes, the magnitude of the applied pressure on the display module can be sensed.

In case that the pressure sensor 430 is integrated with the backlight panel, the top electrode layer 532 can be used as a reflective layer of the backlight panel for reflecting the light beam to the front panel of the display module because the top electrode layer 532 is made of metallic material. When the top electrode layer 532 is used as the reflective layer, the second substrate 538 (i.e., the bottom substrate) further comprises plural bottom sub-electrodes (not shown). According to the changes of capacitances between the top electrode layer 532 and the bottom sub-electrodes, the magnitude of the applied pressure on the display module can be sensed.

In case that the pressure sensor 430 is integrated with the panel frame, the second substrate 538 is considered as the panel frame, and used as a ground metal layer. Since the pressure sensor 430 is integrated with the panel frame, the top electrode layer 532 further comprises plural top sub-electrodes. According to the changes of capacitances between the top sub-electrodes and the second substrate 538, the magnitude of the applied pressure on the display module can be sensed.

FIG. 4E is a schematic cross-sectional view illustrating a fifth example of the pressure sensor according to the present invention. As shown in FIG. 4E, the pressure sensor 430 comprises a first substrate 543, an interlayer 545 and a second substrate 549. The first substrate 543 comprises a top electrode layer 542 and a top substrate 541. The top electrode layer 542 is made of metallic material. In addition, the top substrate 541 is a transparent substrate such as a glass substrate or a plastic substrate. The second substrate 549 comprises a bottom electrode layer 546 and a bottom substrate 547. The bottom electrode layer 546 is made of metallic material or indium tin oxide (ITO). Moreover, the interlayer 545 is arranged between the top electrode layer 542 and the bottom electrode layer 546. In this embodiment, the interlayer 545 is a dielectric interlayer or a resistive layer.

In case that the pressure sensor 430 is a stand-alone pressure sensor, the top electrode layer 542 further comprises plural top sub-electrodes (not shown), and the bottom electrode layer 546 further comprises plural bottom sub-electrodes (not shown). According to the changes of capacitances or electrical resistances between the top sub-electrodes and the corresponding bottom sub-electrodes, the magnitude of the applied pressure on the display module can be sensed.

In case that the pressure sensor 430 is integrated with the backlight panel, the top electrode layer 542 can be used as a reflective layer of the backlight panel for reflecting the light beam to the front panel of the display module because the top substrate 541 is the transparent substrate. When the top electrode layer 542 is used as the reflective layer, the bottom electrode layer 546 further comprises plural bottom sub-electrodes (not shown). According to the changes of capacitances or electrical resistances between the top electrode layer 542 and the bottom sub-electrodes, the magnitude of the applied pressure on the display module can be sensed.

In case that the pressure sensor 430 is integrated with the panel frame, the panel frame is used as the bottom substrate 547, and a ground metal layer is formed on the panel frame to be used as the bottom electrode layer 546. Consequently, the second substrate 549 is constituted by the bottom electrode layer 546 and the bottom substrate 547. Since the pressure sensor 430 is integrated with the panel frame, the top electrode layer 542 further comprises plural top sub-electrodes. According to the changes of capacitances or electrical resistances between the top sub-electrodes and the bottom electrode layer 546, the magnitude of the applied pressure on the display module can be sensed.

FIG. 4F is a schematic cross-sectional view illustrating a sixth example of the pressure sensor according to the present invention. As shown in FIG. 4F, the pressure sensor 430 comprises a first substrate 553, an interlayer 555 and a second substrate 559. The first substrate 553 comprises a top electrode layer 551 and a top substrate 552. The top electrode layer 551 is made of metallic material. The second substrate 559 comprises a bottom electrode layer 557 and a bottom substrate 556. The bottom electrode layer 557 is made of metallic material. Moreover, the interlayer 555 is arranged between the top substrate 552 and the bottom substrate 556. In this embodiment, the interlayer 555 is a dielectric interlayer.

In case that the pressure sensor 430 is a stand-alone pressure sensor, the top electrode layer 551 further comprises plural top sub-electrodes (not shown), and the bottom electrode layer 557 further comprises plural bottom sub-electrodes (not shown). According to the changes of capacitances between the top sub-electrodes and the corresponding bottom sub-electrodes, the magnitude of the applied pressure on the display module can be sensed.

In case that the pressure sensor 430 is integrated with the backlight panel, the top electrode layer 551 can be used as a reflective layer of the backlight panel for reflecting the light beam to the front panel of the display module because the top electrode layer 551 is made of metallic material. When the top electrode layer 551 is used as the reflective layer, the bottom electrode layer 557 further comprises plural bottom sub-electrodes (not shown). According to the changes of capacitances between the top electrode layer 551 and the bottom sub-electrodes, the magnitude of the applied pressure on the display module can be sensed.

In case that the pressure sensor 430 is integrated with the panel frame, the panel frame is used as the bottom substrate 556, and a ground metal layer is formed on the panel frame to be used as the bottom electrode layer 557. Consequently, the second substrate 559 is constituted by the bottom electrode layer 557 and the bottom substrate 556. Since the pressure sensor 430 is integrated with the panel frame, the top electrode layer 551 further comprises plural top sub-electrodes. According to the changes of capacitances between the top sub-electrodes and the bottom electrode layer 557, the magnitude of the applied pressure on the display module can be sensed.

FIG. 4G is a schematic cross-sectional view illustrating a seventh example of the pressure sensor according to the present invention. As shown in FIG. 4G, the pressure sensor 430 comprises a first substrate 563, an interlayer 565 and a second substrate 569. The first substrate 553 comprises a top electrode layer 561 and a top substrate 562. The top electrode layer 551 is made of metallic material. The second substrate 559 comprises a bottom electrode layer 566 and a bottom substrate 567. The bottom electrode layer 566 is made of metallic material or indium tin oxide (ITO). Moreover, the interlayer 565 is arranged between the top substrate 562 and the bottom electrode layer 566. In this embodiment, the interlayer 565 is a dielectric interlayer.

In case that the pressure sensor 430 is a stand-alone pressure sensor, the top electrode layer 561 further comprises plural top sub-electrodes (not shown), and the bottom electrode layer 556 further comprises plural bottom sub-electrodes (not shown). According to the changes of capacitances between the top sub-electrodes and the corresponding bottom sub-electrodes, the magnitude of the applied pressure on the display module can be sensed.

In case that the pressure sensor 430 is integrated with the backlight panel, the top electrode layer 561 can be used as a reflective layer of the backlight panel for reflecting the light beam to the front panel of the display module because the top electrode layer 561 is made of metallic material. When the top electrode layer 561 is used as the reflective layer, the bottom electrode layer 566 further comprises plural bottom sub-electrodes (not shown). According to the changes of capacitances between the top electrode layer 561 and the bottom sub-electrodes, the magnitude of the applied pressure on the display module can be sensed.

In case that the pressure sensor 430 is integrated with the panel frame, the panel frame is used as the bottom substrate 567, and a ground metal layer is formed on the panel frame to be used as the bottom electrode layer 566. Consequently, the second substrate 569 is constituted by the bottom electrode layer 566 and the bottom substrate 567. Since the pressure sensor 430 is integrated with the panel frame, the top electrode layer 561 further comprises plural top sub-electrodes. According to the changes of capacitances between the top sub-electrodes and the bottom electrode layer 566, the magnitude of the applied pressure on the display module can be sensed.

FIG. 4H is a schematic cross-sectional view illustrating an eighth example of the pressure sensor according to the present invention. As shown in FIG. 4H, the pressure sensor 430 comprises a first substrate 573, an interlayer 555 and a second substrate 579. The first substrate 573 comprises a top electrode layer 572 and a top substrate 571. The top electrode layer 572 is made of metallic material. In addition, the top substrate 571 is a transparent substrate such as a glass substrate or a plastic substrate. The second substrate 579 comprises a bottom electrode layer 577 and a bottom substrate 576. The bottom electrode layer 577 is made of metallic material. Moreover, the interlayer 575 is arranged between the top electrode layer 572 and the bottom substrate 576. In this embodiment, the interlayer 575 is a dielectric interlayer.

In case that the pressure sensor 430 is a stand-alone pressure sensor, the top electrode layer 572 further comprises plural top sub-electrodes (not shown), and the bottom electrode layer 577 further comprises plural bottom sub-electrodes (not shown). According to the changes of capacitances between the top sub-electrodes and the corresponding bottom sub-electrodes, the magnitude of the applied pressure on the display module can be sensed.

In case that the pressure sensor 430 is integrated with the backlight panel, the top electrode layer 572 can be used as a reflective layer of the backlight panel for reflecting the light beam to the front panel of the display module because the top substrate 571 is the transparent substrate. When the top electrode layer 572 is used as the reflective layer, the bottom electrode layer 577 further comprises plural bottom sub-electrodes (not shown). According to the changes of capacitances between the top electrode layer 572 and the bottom sub-electrodes, the magnitude of the applied pressure on the display module can be sensed.

In case that the pressure sensor 430 is integrated with the panel frame, the panel frame is used as the bottom substrate 576, and a ground metal layer is formed on the panel frame to be used as the bottom electrode layer 577. Consequently, the second substrate 579 is constituted by the bottom electrode layer 577 and the bottom substrate 576. Since the pressure sensor 430 is integrated with the panel frame, the top electrode layer 572 further comprises plural top sub-electrodes. According to the changes of capacitances between the top sub-electrodes and the bottom electrode layer 577, the magnitude of the applied pressure on the display module can be sensed.

In the above embodiments, the present invention provides the display module with the pressure sensor. The pressure sensor is disposed under the backlight panel, and clamped between the backlight panel and the frame panel. When an applied pressure is received by the front panel, a magnitude of the applied pressure is sensed by the pressure sensor.

As mentioned above, the interlayer is a dielectric interlayer or a resistive layer. For example, the dielectric interlayer comprises plural dielectric material layers in a stack arrangement, or the interlayer is a layer of air. Similarly, the resistive layer comprises plural resistive material layers in a stack arrangement, and the resistive layer is made of electrically-conductive rubber or foam.

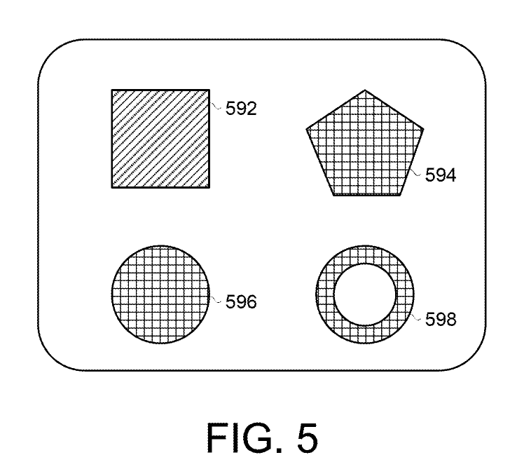

Moreover, the top sub-electrodes of the top electrode layer or the bottom sub-electrodes of the bottom electrode layer are patterned electrodes. FIG. 5 schematically illustrates some kinds of patterned electrodes. As shown in FIG. 5, the patterned electrodes include rectangular electrodes 592, polygonal electrodes 594, circular electrodes 596 or hollow circular electrodes 598. It is noted that the shapes of the patterned electrodes are not restricted.

From the above descriptions, the present invention provides a display module with a pressure sensor. Since the pressure sensor is disposed under a backlight panel of the display module, the illuminance of the display module is not adversely affected by the pressure sensor. Moreover, the structure of the display module is simplified.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display module, comprising:
a front panel comprising an array of display pixels;
a backlight panel disposed under the front panel;
a pressure sensor disposed under the backlight panel; and
a panel frame disposed under the pressure sensor,
wherein when an applied pressure is received by the front panel, a magnitude of the applied pressure is sensed by the pressure sensor.

2. The display module as claimed in claim 1, wherein the pressure sensor comprises a first substrate, an interlayer and a second substrate, and the interlayer is arranged between the first substrate and the second substrate, wherein the first substrate comprises a top electrode layer, the second substrate comprises a bottom electrode layer, and the interlayer is a dielectric interlayer or a resistive layer.

3. The display module as claimed in claim 2, wherein if the interlayer is the dielectric interlayer and the applied pressure is received by the front panel, the magnitude of the applied pressure is sensed according to a change of a capacitance between the top electrode layer and the bottom electrode layer, wherein if the interlayer is the resistive layer and the applied pressure is received by the front panel, the magnitude of the applied pressure is sensed according to a change of an electrical resistance between the top electrode layer and the bottom electrode layer.

4. The display module as claimed in claim 2, wherein the first substrate comprises the top electrode layer and a top substrate, the top electrode layer comprises plural top sub-electrodes, and the plural top sub-electrodes are made of metallic material or indium tin oxide; or wherein the second substrate comprises the bottom electrode layer and a bottom substrate, the bottom electrode layer comprises plural bottom sub-electrodes, and the plural bottom sub-electrodes are made of the metallic material or indium tin oxide.

5. The display module as claimed in claim 4, wherein the bottom electrode layer is a ground metal layer.

6. The display module as claimed in claim 2, wherein the dielectric interlayer comprises plural dielectric material layers in a stack arrangement, or the interlayer is a layer of air.

7. The display module as claimed in claim 2, wherein the resistive layer comprises plural resistive material layers in a stack arrangement, and the resistive layer is made of electrically-conductive rubber or foam.

8. A display module, comprising:
a front panel comprising an array of display pixels;
a pressure sensor disposed under the front panel, and comprising a reflective layer; and
a panel frame disposed under the pressure sensor,
wherein when an applied pressure is received by the front panel, a magnitude of the applied pressure is sensed by the pressure sensor.

9. The display module as claimed in claim 8, wherein the pressure sensor comprises a first substrate, an interlayer and a second substrate, and the interlayer is arranged between the first substrate and the second substrate, wherein the first substrate comprises a top electrode layer, the second substrate comprises a bottom electrode layer, and the interlayer is a dielectric interlayer or a resistive layer, wherein the top electrode layer of the first substrate is also used as the reflective layer.

10. The display module as claimed in claim 9, wherein if the interlayer is the dielectric interlayer and the applied pressure is received by the front panel, the magnitude of the applied pressure is sensed according to a change of a capacitance between the top electrode layer and the bottom electrode layer, wherein if the interlayer is the resistive layer and the applied pressure is received by the front panel, the magnitude of the applied pressure is sensed according to a change of an electrical resistance between the top electrode layer and the bottom electrode layer.

11. The display module as claimed in claim 9, wherein the first substrate comprises the top electrode layer and a top substrate, and the top electrode layer is also used as the reflective layer, wherein the second substrate comprises the bottom electrode layer and a bottom substrate, the bottom electrode layer comprises plural bottom sub-electrodes, and the plural bottom sub-electrodes are made of the metallic material or indium tin oxide.

12. The display module as claimed in claim 9, wherein the dielectric interlayer comprises plural dielectric material layers in a stack arrangement, or the interlayer is a layer of air.

13. The display module as claimed in claim 9, wherein the resistive layer comprises plural resistive material layers in a stack arrangement, and the resistive layer is made of electrically-conductive rubber or foam.

14. A display module, comprising:
a front panel comprising an array of display pixels;
a backlight panel disposed under the front panel; and
a pressure sensor disposed under the backlight panel, and comprising a panel frame, wherein the panel frame is located at a lower portion of the pressure sensor,
wherein when an applied pressure is received by the front panel, a magnitude of the applied pressure is sensed by the pressure sensor.

15. The display module as claimed in claim 14, wherein the pressure sensor comprises a first substrate, an interlayer and a second substrate, and the interlayer is arranged between the first substrate and the second substrate, wherein the first substrate comprises a top electrode layer, the second substrate comprises a bottom electrode layer, and the interlayer is a dielectric interlayer or a resistive layer.

16. The display module as claimed in claim 15, wherein if the interlayer is the dielectric interlayer and the applied pressure is received by the front panel, the magnitude of the applied pressure is sensed according to a change of a capacitance between the top electrode layer and the bottom electrode layer, wherein if the interlayer is the resistive layer and the applied pressure is received by the front panel, the magnitude of the applied pressure is sensed according to a change of an electrical resistance between the top electrode layer and the bottom electrode layer.

17. The display module as claimed in claim 15, wherein the first substrate comprises the top electrode layer and a top substrate, the top electrode layer comprises plural top sub-electrodes, and the plural top sub-electrodes are made of metallic material or indium tin oxide, wherein the bottom electrode layer is a ground metal layer.

18. The display module as claimed in claim 15, wherein the dielectric interlayer comprises plural dielectric material layers in a stack arrangement, or the interlayer is a layer of air.

19. The display module as claimed in claim 15, wherein the resistive layer comprises plural resistive material layers in a stack arrangement, and the resistive layer is made of electrically-conductive rubber or foam.

20. A display module, comprising:
an illumination module having a light-outputting surface and a backside surface, wherein the light-outputting surface and the backside surface are opposed each other with respect to the illumination module;
a panel frame; and
a pressure sensor arranged between the backside surface of the illumination module and the panel frame.

21. The display module as claimed in claim 20, wherein the pressure sensor comprises a top electrode layer, a bottom electrode layer, and an interlayer arranged between the top electrode layer and the bottom electrode layer, wherein a metal layer on the backside surface of the illumination module is shared with the top electrode layer.

22. The display module as claimed in claim 20, wherein the pressure sensor comprises a top electrode layer, a bottom electrode layer, and an interlayer arranged between the top electrode layer and the bottom electrode layer, wherein a metal layer on a top surface of the panel frame is shared with the bottom electrode layer.

23. The display module as claimed in claim 20, wherein the illumination module is a LCD illumination module or an organic light-emitting module.
